(19) United States
(12) Patent Application Publication
(10) Pub. No.: US 2011/0255919 A1
(43) Pub. Date: Oct. 20, 2011

(54) Self-Propelled Surface Cutter Having Fixed Support of the Rotary Cutter Drive

(75) Inventors: Klaus Graner, Ahlen (DE); Norbert Hausladen, Biberach/Risse (DE); Viktor Schindler, Uttenweiler (DE)

(73) Assignee: Liebherr-Werk Biberach GmbH, Biberach an der Risse (DE)

(21) Appl. No.: 13/087,740

(22) Filed: Apr. 15, 2011

(30) Foreign Application Priority Data
Apr. 16, 2010 (DE) 10 2010 014 168.8
Jun. 8, 2010 (DE) 10 2010 023 024.3

(51) Int. Cl. E01C 23/12; F16C 19/24

(52) U.S. Cl. 404/90; 384/548

(57) ABSTRACT

The present invention relates to a self-propelled surface cutter, preferably in the form of an asphalt cutter, a snow cutter or a surface miner, having working equipment including a rotatingly drivable roller body, and having at least one roller drive unit which is received in the interior of the roller body and forms at least one part of a rotatable support of the roller body at a roller carrier frame, wherein the rotatable support of the roller body includes at least two roller bearing arrangements which support the roller body at two roller carrier frame parts engaging around the roller body at the end face, wherein each of the named two roller bearing arrangements on its own forms a statically determined or overdetermined radial and axial support which includes at least two mutually spaced apart bearing points and supports the roller body at the respective roller carrier frame part in an axially and radially fixed manner and/or at a fixed angle to one another so that the roller body overall is supported with static overdetermination at the roller carrier frame. In accordance with the invention, an axial compensation apparatus for compensating deviations of the axial spacing of the two roller bearing arrangements from the axial spacing of the bearing fastening points of the roller carrier frame parts is provided at the roller carrier frame and/or between the roller carrier frame and one of the roller bearing arrangements. An axial restriction and axial overloads of the roller bearing arrangements are, hereby avoided which are themselves tilt-resistant as well as radially fixed and axially fixed and thus axially non-resilient, which in turn suppresses or avoids overload and offset impairing the leak-tightness of the sealing elements for sealing the at least one drive unit. Sealing apparatus such as floating ring seals which are more sensitive to offset, but which seal better, can hereby be used.

### BACKGROUND OF THE INVENTION

The present invention relates to a self-propelled surface cutter, preferably in the form of an asphalt cutter, a snow cutter or a surface miner, having working equipment including a rotatingly drivable roller body, and having at least one roller drive unit which is received in the interior of the roller body and forms at least one part of a rotatable support of the roller body at a roller carrier frame, wherein the rotatable support of the roller body includes at least two roller bearing arrangements which support the roller body at two roller carrier frame parts engaging around the roller body at the end side, wherein each of the named two roller bearing arrangements on its own forms a statically determined or overdetermined radial and axial support which includes at least two mutually spaced apart bearing points and supports the roller body at the respective roller carrier frame part in an axially and radially fixed manner and/or at a fixed angle to one another so that the roller body overall is supported with static overdetermination at the roller carrier frame.

Surface cutters, for example in the form of surface miners, are continuously working open-cast mining plant which comminute the rock or the ground in a cutting manner with the aid of a rotating roller and usually progress continuously with the aid of a crawler track to drive the roller into the rock. The named roller in this respect forms the main piece of working equipment which requires high power and in this respect a suitable drive. In this respect, DE 10 2007 007 996 B4 proposes a diesel-electric drive in which the rotary cutter of the surface miner is driven by means of an electric motor which is supplied with power from a generator which is in turn driven by a diesel plant. Further embodiments of surface miners are also shown in documents WO 03/058031 A1, DE 10 2008 008 260 A1, DE 10 2007 044 090 A1, DE 10 2007 028 812 B4, DE 199 41 800 C2, DE 199 41 799 C2 or DE 20 2007 002 403 U1, wherein, instead of the electric motor drives, hydraulic drives are also used in part which are fed with hydraulic energy by a hydraulic pump driven by the diesel engine.

A surface miner having an inwardly disposed electric motor drive for the rotary cutter is known from DE 10 2007 007 996 B4. In this respect, two variable squirrel-cage motors are received in the interior of the rotary cutter body in each case with an associated planetary drive so that the rotary cutter drives are well protected against external influences and damage, e.g. by stones. To protect the transmissions and the electric motor from dust in each case, the oppositely disposed end faces of the motor-transmission unit seated in a tubular frame piece are closed by pot-shaped housing parts which are in each case connected to a ring seal at the carrier frame in a dust-tight manner. In this respect, the housing of the motor-transmission unit simultaneously serves the support of the roller body at the said carrier frame. A fixed housing part surrounding the electric motor is rigidly connected to a carrier frame part which engages into the roller body at the end face. A rotating housing part which is connected to the roller body and which surrounds the transmission is rotatably supported at the named fixed housing part by a roller bearing and is sealed by a ring seal.

With such encapsulated electric drives in the interior of the rotary cutter, however, thermal problems arise since the heat arising at the motor and at the transmission is not sufficiently dissipated.

Furthermore, the sealing of the housing is critical in such motor-transmission units which support the rotary cutter and which are used for the rotational support of the named rotary cutter. The rotating housing part is namely sensibly not only sealed in a dust-tight manner with respect to the stationary housing part, but also in an oil-tight manner so that the transmission can run in the oil bath. Corresponding seals such as floating-ring seals are sensitive to axial and radial offset as well as to angular offset which can easily occur due to the high forces introduced between the two housing parts when the support in the proximity of the seal does not prevent it.

A neat sealing of the named housing parts is, however, not only necessary to avoid oil leaks, but also due to the often dusty operating conditions. An introduction of dust into the housing interior and thus into the transmission and into the electric motor would dramatically reduce the service life of the motor-transmission unit so that suitable measures are also necessary against the introduction of dust into the motor.

A rotary cutter of a surface miner having a roller drive arranged in the interior of the roller body is known from DE 100 59 841 C1, wherein, however, the roller drive does not have an electric motor, but is rather designed hydraulically so that the named cooling problem and the accompanying sealing of the drive unit is not present to the same degree as in electric motors. The hydraulic motors are in this respect arranged in separate motor reception cylinders which are arranged coaxially in the interior of the roller body and are each rotatably supported at the roller body via a fixed-and-floating support, whereas they are suspended in an oscillating manner at a roller carrier frame, on the other hand. The oscillating support may compensate an angular offset which can result on a deflection of the rotary cutter. However, due to tolerances and/or thermal distensions and/or elastic deformations by this fixed-and-floating support at both sides, axial tensions result which cannot be compensated by the oscillating pivotal connection and which can result in an overload of the fixed bearing in the axial direction and thus to its destruction. The hydraulic motors themselves are supported in the interior of the motor reception cylinders open at one side by means of a ring-shaped torque support, but in another respect spaced apart from the reception cylinders so that the motor housing itself is not involved in the support of the rotary cutter body.

### SUMMARY OF THE INVENTION

It is therefore the underlying object of the present invention to provide an improved surface cutter of the initially named kind which avoids disadvantages of the prior art and further develops the latter in an advantageous manner. A leak-free and dust-tight seal of the rotary cutter drive should in particular be realized without an axial overload of the fixed bearings despite the dissipation of the roller bearing forces over the drive units without this being done at the cost of an increased adverseness to maintenance and assembly.

This object is achieved in accordance with the invention by a surface cutter as described herein. Preferred embodiments of the invention are also the subject of the description herein.

It is therefore proposed to provide each roller drive unit discretely with a radial and axial support between the housing parts which is each discretely statically determined or even over-determined and suppresses both axial/radial displacements and angular displacements of the housing parts relative to one another. In the case of a plurality of drive units in the roller body, it is accepted for this purpose that the roller bearing overall is statically over-determined per se, with unwanted tensions and restrains being countered by a compensation device. So that in particular a sealing apparatus between the drive housing parts rotatable with respect to one another does not undergo any axial, radial and/or angular displacements which would result in leaks and would endanger the dust-tightness, the drive housing parts are not only pivotably supported at one another by a respective bearing, but are also supported by a plurality of bearing points having a large support spacing and thus supported flexurally rigidly at one another and fixed axially to one another. In accordance with the invention, an axial compensation apparatus for setting the axial spacing of the two roller bearing arrangements from the axial spacing of the bearing fastening points of the roller carrier frame parts is provided at the roller carrier frame and/or between the roller carrier frame and one of the roller bearing arrangements. An axial restriction due to tolerances and axial overloads of the roller bearing arrangements are hereby avoided which are themselves tilt-resistant as well as radially fixed and axially fixed and thus axially non-resilient, which in turn suppresses or avoids overload and offset impairing the leak-tightness of the sealing elements for sealing the at least one drive unit. Sealing apparatus such as floating ring seals which are more sensitive to offset, but which seal better, can hereby be used to be able to ensure oil-tightness for the transmission and/or the bearings and to be able to use more dust-resistant and contamination-resistant electric motors. The axial compensation apparatus allows an axial displacement of the bearing fastening points of the roller carrier frame parts relative to one another in the axial direction, advantageously without an accompanying tilt of the named bearing fastening parts to avoid bending restrictions or tilt restrictions on the axial displacement.

In a further development of the invention, the named bearing adjustment apparatus can include at least one movable frame bearing point by which the at least one of the roller carrier frame parts to which one of the roller bearing arrangements is fastened is axially movably supported to permit axial compensation movements. At least one of the roller carrier frame parts engaging around the roller body at the end face can therefore move in the direction of the longitudinal roller body axis due to the movable frame bearing point so that the axial spacing from one another of the bearing fastening points provided at the named roller carrier frame parts for the roller bearing arrangements can be adapted to the axial spacing of the roller bearing arrangements or deviations in the axial direction from spacing tolerances and/or thermal distensions and/or elastic deformations can be compensated. The movable frame bearing point is in particular displaceably or movably supported in a linear manner parallel to the longitudinal axis or the axis of rotation of the roller body so that the axial movement of the frame bearing point can be carried out substantially without transverse movements or tilt movements.

The movable frame bearing point can generally have different designs to permit the named axial compensation movement of the roller carrier frame parts with respect to one another. For example, one of the roller carrier frame parts could be suspended in the manner of a parallelogram arm guide to be able to be moved parallel to the longitudinal roller body axis.

The named movable frame bearing point can, however, in particular have an axial sliding guide with an axial displaceability parallel to the axis of rotation of the roller. The roller carrier frame part to which the respective drive unit and/or roller bearing arrangement is fastened hereby becomes longitudinally displaceable in the longitudinal roller direction.

The axial movability of the roller carrier frame parts relative to one another is, in an advantageous further development of the invention, also present during the operation of the surface cutter, i.e. the spacing of the roller carrier frame parts engaging laterally around the roller body can also change in cutting operation with a rotating roller and can be adapted to the spacing of the roller bearing arrangements from one another, for example to compensate thermal distensions. Provision can alternatively also be made to associate a braking apparatus with the movable frame part by means of which the degree of freedom of the movable frame bearing point can be blocked for operation. In this case, the free movability on a standstill or in a machining break could be utilized to adapt the axial spacing of the bearing fastening points to the roller carrier frame parts to the axial spacing of the roller bearing arrangements, for example when the rotary cutter has reached operating temperature, whereby excessive axial tensions could likewise be avoided.

To avoid restrictions and tensions, in a further development of the invention, the axial compensation apparatus can also have a position adjustment apparatus by means of which at least one of the bearing fastening points to which the respective roller bearing arrangement is fastened at the respective roller bearing frame part can be moved, in particular axially displaced, relative to the respective roller carrier frame part. A rigid roller carrier frame can hereby also be used without the previously described movable frame bearing point having to be provided, with a combination of the named bearing adjustment apparatus and of the previously named movable frame bearing point, however, also being able to be provided.

The named position adjustment apparatus can in this respect in particular include axial adjustment means to mutually adjust the axial span of the bearing fastening points provided at the roller carrier frame parts relative to one another by which the named roller carrier frame parts are connected to the roller bearing arrangements. Such axial adjustment means make it possible to adapt the spacing of the named bearing fastening points at the roller carrier frame parts from one another to the spacing of the drive units or roller bearing arrangements fixed in the roller body and to avoid axial tensions from tolerances.

In a simple embodiment of the invention, the named axial adjustment means can include adjustment washers which can be provided at at least one flange connection of the roller carrier frame to the machine frame or also at the flange connection between the roller carrier frame and the respective drive unit. The spacing dimension of the roller carrier frame parts or of the bearing fastening parts provided thereat to the spacing dimension of the drive units is adapted by inserting more or fewer adjustment washers.

It is prevented by the named axial adjustment means in the form of adjustment washers or of the named sliding guide that longitudinal deviations due to tolerances and/or thermal distensions cause too high an axial tension of the roller bearing arrangement between the drive housing parts.

Alternatively or additionally to the previously named embodiment options of the axial compensation apparatus, an axial movability of the two bearing fastening points of the roller carrier frame parts can also be achieved in an advantageous further development of the invention in that at least one of the carrier arms of the roller carrier frame engaging around the roller body is designed as resilient and deformable, in particular flexible, so that the corresponding carrier arm is displaced in the axial direction, for example on thermal distensions or other axial distensions, and yields to the tension or distension on the build-up of only small axial forces. The named carrier arm is in particular so flexible or deformable that the bearing point fastened to the carrier arm is displaceable in the axial direction without undergoing a tilt or a transverse movement component, which can, for example, be achieved in that the named carrier arm of the roller carrier frame can adopt an S-shaped deformation or a deformation bulging in the opposite direction.

In an advantageous further development of the invention, the carrier arms of the roller carrier frame engaging around the roller body at an end face can have different designs, preferably such that one of the carrier arms is rigid, in particular axially rigid, to guide the roller body transversely to the cutting direction, while the other carrier arm is designed as flexible in the aforesaid manner.

Alternatively or additionally, in accordance with a further aspect of the present invention, provision can be made that one of the carrier arms of the roller carrier frame engaging around the roller body at an end face is made considerably thinner in the axial direction than the other carrier arm at the oppositely disposed end of the roller body. Due to such a thin design in the axial direction at one side, the aforesaid flexibility can be achieved, on the one hand, and, on the other hand, an improved side cutting can be achieved since the thin design of the carrier arm requires a smaller spacing from the side edges such as cutting edges.

In a further development of the invention, the roller bearing arrangement at the drive unit advantageously includes a bearing point directly beneath or indirectly beneath the sealing apparatus as well as a bearing point considerably spaced apart from the sealing apparatus so that overall a large support spacing is achieved and the bearing is flexurally rigid overall. At the same time, radial offset at the sealing apparatus is fully suppressed by the arrangement of a bearing point directly at the sealing apparatus. Angular offset is simultaneously suppressed in interaction with the further bearing point spaced apart therefrom.

Expediently, a bearing point is provided above the motor, preferably directly at or as close as possible to the frame stem, whereas a further bearing point is arranged at the transmission input. A bearing point can in particular be arranged at the half of the electric motor housing arranged remote from the transmission, whereas a further bearing point can be provided in the transition region between the electric motor and the transmission. By such a spaced-apart arrangement with a large bearing spacing, small radial forces acting on the bearings from the global bending torques in the total construction of roller plus frame are achieved which in turn reduce the required resistance torque of the stems of the frame construction leading upward to the machine and thus allow an inexpensive frame construction.

In a further development of the invention, at least one of the roller bearing arrangements, which are each made in the aforesaid manner as radially fixed and axially fixed, tilt resistant fixed-and-floating support with at least two spaced apart bearing points, is integrated into one of the roller drive units or into the at least one roller drive unit, with the named roller drive unit including a stationary drive housing part fastened to one of the roller carrier frame parts as well as a rotatable drive housing part connected to the roller body, which are mutually sealed by a sealing apparatus, on the one hand, and which are supported in an axially and radially fixed manner and with a fixed angle to one another by the named integrated roller bearing arrangement, on the other hand. The bearing and support forces of the roller body are, on the one hand, directly dissipated via the drive unit by the integration of the roller bearing arrangement into the drive unit. On the other hand, separate support cylinders such as were known from the prior art can be dispensed with so that additional construction space for the drive units is also achieved in addition to a reduction in the number of parts.

In a further development of the invention, the stationary drive housing part fixedly connected to the roller carrier frame can be formed by a bell housing which is placed over the motor housing of the electric motor. The named bell housing is therefore drawn over the motor toward the roller carrier frame part. In this case, the named bell housing can also form or receive the bearing shell for the bearing arranged above the electric motor.

Alternatively or additionally, the motor housing of the electric motor can also form or receive a bearing shell for one of the roller bearings. In this case, the named transmission bell can be fully dispensed with, with the motor housing forming a carrying housing part. This results in a simple and slim solution because the named support bell can be dispensed with. The motor housing of the electric motor therefore at least partly forms the fixed drive housing part.

The rotatable drive housing part is advantageously formed by an outer transmission housing part.

The roller bearing arrangement itself can generally have different designs. In accordance with an advantageous embodiment of the invention, the roller bearing arrangement of at least one drive unit can include a fixed bearing, preferably in the form of a double tapered roller bearing in the X arrangement as well as a radial bearing spaced apart therefrom. The named double tapered roller bearing forms an axial bearing which fixes the axial position of the two drive housing parts relative to one another.

Alternatively or additionally, the roller bearing arrangement of at least one drive unit or of one further drive unit of two conical roller bearings spaced apart from one another can be provided in an O arrangement or in an “<>” arrangement which can simultaneously transmit high axial and radial forces and absorb tilt moments. On the use of such a tapered roller bearing in an O arrangement, the sealing apparatus can advantageously be arranged close to or above one of the roller body sets. Instead of tapered roller bearings, sloping ball bearings can also be used to achieve—in dependence on the arrangement of the two sloping ball bearings—the previously named X arrangement or O arrangement as well as the corresponding axially fixed support.

The sealing apparatus between the mutually movable drive housing parts can generally have different designs. In accordance with an advantageous embodiment of the invention, the sealing apparatus can include at least one floating ring seal. A plurality of floating ring seals can advantageously also be provided. Such floating ring seals are admittedly more sensitive with respect to axial and/or radial and/or angular offset of the components to which they are attached; on the other hand, however, they allow a very much better sealing effect, in particular under the effect of dust, than simple radial shaft sealing rings, for example. The named higher sensitivity is, however, taken into account by the tilt-resistant and axially and radially fixed fixed-and-floating support of the drive housing parts relative to one another so that this property of the floating ring seals can be accepted without disadvantages arising therefrom.

An increased seal tightness is in particular of advantage when the drive unit has at least one electric motor which can be connected to a transmission, in particular to an oil-filled transmission, via which the drive movement of the electric motor shaft is transmitted onto the roller body with a corresponding step-up/step-down. In this respect, the previously described bearing and seal concept is particularly of advantage for rotary cutters driven by an electric motor.

A sealing apparatus can advantageously be arranged over the outer periphery of the motor housing of the electric motor. Alternatively or additionally, the sealing apparatus can be arranged between the electric motor and the transmission, viewed in the axial direction of the roller drive, between the named drive housing parts, in particular approximately in the region of the transmission input.

In an advantageous further development of the invention, the drive unit can be of concentric design, i.e. the electric motor and the transmission connected thereto can be arranged on one axis.

Alternatively, however, an axially offset design of the drive unit can also be provided in which the at least one electric motor is arranged with its motor shaft offset transversely to the transmission shaft. This can in particular be advantageous when a plurality of electric motors are provided which are associated with a common transmission unit. Furthermore, with an axially offset arrangement of the electric motor and of the transmission, a further transmission stage can be provided between the motor shaft and the transmission input shaft. The use of smaller motors can hereby be achieved in interaction with the arrangement of a plurality of electric motors in order again to achieve the required total power. In addition, the motors are in this case higher than a central motor, whereby they can be better protected against damage.

It is furthermore proposed to associate a cooling apparatus having a closed liquid cooling circuit with the electric motor of the rotary cutter drive arranged in the interior of the rotary cutter body. Due to the high heat capacity of a suitable cooling liquid such as oil or water-glycol mixture, small volume flows in the liquid cooling circuit and thus small line cross-sections are sufficient. On the other hand, all dust entry into the rotary cutter drive and also any dust development through exhaust air can be avoided by the closed design of the liquid cooling circuit.

The heat dissipation from the cooling liquid can generally take place in different ways. In a preferred further development of the invention, the liquid cooling circuit has a heat exchanger arranged outside the rotary cutter for cooling the cooling liquid which is connected to a section of the liquid coolant circuit associated with the electric motor via cooling liquid lines which are conducted out of the rotary cutter at an end face and which can preferably extend at or in the support frame for supporting the roller body. The named heat exchanger could generally also be arranged in the interior of the rotary cutter, but outside the motor housing, to output the heat from the cooling liquid to the environment. However, with an arrangement outside the rotary cutter, environmental air can flow better toward the oil cooler or heat exchanger for cooling the cooling liquid. The named heat exchanger can advantageously be arranged at a point considerably above the rotary cutter at the machine to avoid a clogging of the heat exchanger by dust. Different positions can generally be considered for the positioning of the heat exchanger.

The rotating drive housing part of the at least one roller drive unit, which advantageously forms a transmission housing part, is rotationally fixedly connected to the roller body by at least one connection point in an advantageous embodiment of the invention, with the named bearing point generally being able to be different designs, for example being able to include a screw connection between the drive housing part and the roller body or a fastening flange connected thereto, but also being able to have other connection means. To prevent fretting corrosion at the named connection point, in an advantageous embodiment of the invention, a lubricant reservoir can be provided at the interior of the roller body for lubricating the named connection point or for protecting the connection point from fretting corrosion. Lubricant can move from the named lubricant reservoir onto the fit surfaces of the connection point between the drive housing part and the roller body so that the arising of fretting corrosion there can be prevented or at least reduced.

Advantageously, the named lubricant reservoir can form a lubricant bath whose level lies at least above a lower section of the connection point so that the connection point continuously runs through the lubrication bath over its full periphery on rotation of the roller body.

The lubricant bath is advantageously designed or is influenced by its level so that at least some of the drive housing part is also wetted. Not only the named connection point can hereby be protected against fretting corrosion, but simultaneously the surface of the roller drive unit, in particular of the transmission, can be cooled. Since lubricants such as oil have a high heat capacity, the cooling effect for the drive housing part and the drive part surrounded by it is relatively high, particularly since the heat introduced into the lubricant via the roller body, which has a very large surface toward the outside, is effectively conducted away. Any required drive cooling or transmission cooling can hereby advantageously be designed smaller or less powerful.

To improve the lubricant wetting of the drive housing part and hereby to improve the heat dissipation, in a further development of the invention, circulation elements, for example in the form of web plates, can be provided in the interior of the roller body which mix the lubricant over and over again by the rotation of the roller body and take the lubricant upward on rotation of the drum.

The connection point and/or the inner space of the roller body can advantageously be sealed with respect to the rotating drive housing part 34 and/or toward the outside by a sealing apparatus in a lubricant-tight manner, preferably in a fluid-tight manner, with the named sealing apparatus preferably being able to be integrated into the connection point and being able to be formed in the form of an O ring, for example.

Further advantageous embodiments of the surface cutter and of its roller drive result from the claims, but also from the following description and the associated Figures, with individual features alone or in combination and sub-combination with one another being able to be the subject of the invention independently of the grouping of the features in the claims.

### BRIEF DESCRIPTION OF THE DRAWINGS

The invention will be explained in more detail in the following with respect to preferred embodiments and to associated drawings. There are shown in the drawings:

FIG. 1: a schematic, perspective representation of a travelable surface cutter which is made in the form of a surface miner, but can also be made as an asphalt cutter, in accordance with an advantageous embodiment of the invention;

FIG. 2: a schematic longitudinal section through the rotary cutter of the surface cutter of FIG. 1 which shows the rotary cutter drives received in the interior of the rotary cutter in each case in the form of an electric motor having a planetary transmission coupled thereto;

FIG. 3: a longitudinal section through one of the electric motors of FIG. 2 which shows the closed cooling air circuit in the sealed motor housing, with the cooling air being guided through axial cooling air cut-outs in the rotor in the opposite direction from a winding head space to the oppositely disposed winding head space and back;

FIG. 4: a longitudinal section through one of the electric motors of FIG. 2 in accordance with a further embodiment of the invention in accordance with which a radial fan is provided on the shaft outside the bearing bracket of the motor;

FIG. 5: a longitudinal section through one of the electric motors of FIG. 2 in accordance with a further advantageous embodiment of the invention in accordance with which the electric motor is made as a synchronous motor with a permanent magnet rotor and the cooling air circuit is provided for cooling the winding heads and is guided through cut-outs in the rotor in the opposite direction from the one winding head space to the oppositely disposed winding space and back;

FIG. 6: a longitudinal section through a rotary cutter drive in the interior of the rotary cutter of the surface cutter of FIG. 1 in accordance with an alternative embodiment of the invention in accordance with which an electric motor is arranged axially offset to the transmission shaft and the bearing arrangement between the drive housing parts comprises a spaced apart tapered roller bearing arrangement in O position and the sealing apparatus is arranged in the region of the transmission input;

FIG. 7: a longitudinal section through the rotary cutter of the surface cutter of FIG. 1 in accordance with an alternative embodiment of the invention in accordance with which a drive unit is only provided on one side of the rotary cutter, whereas the oppositely disposed side of the rotary cutter is supported by an additional bearing arrangement;

FIG. 8: a longitudinal section through a drive unit in the interior of the rotary utter, similar to the embodiment in accordance with FIG. 2, wherein the pump and brake of the drive unit, which are arranged at the shaft end of the electric motor opposite the transmission, are shown in section;

FIG. 9: a longitudinal section through a drive unit in the inter of the rotary cutter, similar to FIG. 8, in accordance with a further embodiment of the invention, in which the circulating lubrication of the transmission has a lubricant filter with bypass arranged outside the rotary cutter;

FIG. 10 a longitudinal section through the roller cutter of the surface cutter of FIG. 1, similar to FIG. 2, in accordance with a further embodiment of the invention, in which the roller carrier frame parts are connected to the machine frame by a position adjustment apparatus in the form of adjustment washers;

FIG. 11: a schematic longitudinal section through the rotary cutter of the surface cutter of FIG. 1 in accordance with a further embodiment of the invention, in which one of the roller carrier frame parts is displaceably guided at the machine frame via a slide guide in order to compensate tolerances and to prevent axial tensions:

FIG. 12: a longitudinal section through a drive unit in the interior of the rotary cutter in accordance with a further embodiment of the invention, in which the motor housing of the electric motor forms or accepts a bearing shell for one of the roller supports of the rolling bearing arrangement between the drive housing parts; and

FIG. 13: a schematic longitudinal section through the rotary cutter of the surface cutter of FIG. 1 in accordance with a further advantageous embodiment of the invention, in which one of the carrier arms of the roller carrying frame engaging around the roller body at an end face is made as thin and flexible to permit axial compensation movements between the bearing points;

FIG. 14: a longitudinal section through a rotary roller drive in the interior of the rotary cutter of the surface cutter of FIG. 1 in accordance with a further advantageous embodiment of the invention, in accordance with which a lubricant bath is provided at the interior of the roller body to prevent fretting corrosion and to cool the transmission.

### DESCRIPTION OF THE PREFERRED EMBODIMENTS

FIG. 1 shows a self-propelled surface cutter such as a surface miner or asphalt cutter whose main piece of working equipment forms a drivable rotary cuter 2 which is rotatable about a horizontal axis and to whose periphery cutting tools are attached to comminute a ground layer or an asphalt layer. The surface cutter 1 is in this respect moved continuously by means of the crawler tracks 3 so that the named rotary cutter 2 continuously undergoes an advance movement. The machine body 4, which is supported by the named crawler tracks 4 in a manner movable on the ground and carries the named rotary cutter 2, furthermore includes conveying means for conveying out the cut material. Coming from the rotary cutter, the cut material is taken over onto a receiving conveyor 5 which transfers the material onto a loading conveyor 6 to load the comminuted material over onto a truck, for example. The named receiving and loading conveyors 5 and 6 can be made as belt systems, for example.

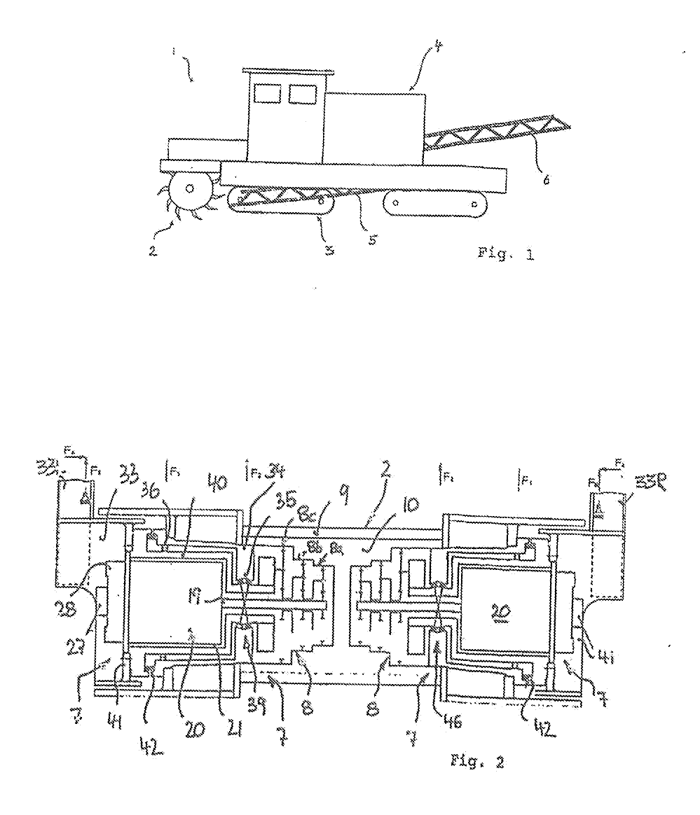

The aforesaid rotary cutter 2 can be driven in accordance with FIG. 2 by means of electric motors 20 which can be connected to the rotary cutter 2 via a transmission in the form of a planetary gear transmission 8 and can optionally be accommodated in the interior of the rotary cutter. The rotary cutter drives 7 respectively comprising an electric motor 20 and a planetary gear transmission 8 simultaneously serve the support of the roller body 9. As FIG. 2 shows, the two rotary cutter drives 7 are arranged at the right and at the left in the interior of the roller body 9 so that, where possible, they do not project beyond the end face of the roller body 9. The electric motor 20 of each rotary cutter drive 7 is in this respect rigidly fastened at its motor housing 21 via a transmission housing part 40 to a carrier frame part 33 which engages into the roller body 9 at an end face and is connected to the machine body 4 of the surface cutter 1. Alternatively, the motor housing 21 can form a part of the transmission housing. A second transmission housing part 34 is, in contrast, rotatably supported, with advantageously a two-point support being provided which is spaced as far as possible apart from one another and which is overall formed in an axially and radially fixed manner and with a fixed angle. In the drawn embodiment in accordance with FIG. 2, a tapered fixed bearing 35 and a radial bearing 36 spaced apart therefrom is provided, cf. FIG. 2.

The named transmission 8 is advantageously formed in the form of a planetary transmission which can be designed in multiple stages to be able to realize a correspondingly large transmission ratio in a small construction space.

In the embodiment shown in FIG. 2, the transmission 8 and the electric motor 20 are arranged coaxially to one another. The motor shaft 19 is connected to the transmission input shaft or forms the transmission input shaft which drives the first planetary gear stage 8A at its free end via corresponding pinions. The further planetary gear stages 8B and 8C are successively driven via the planetary carrier until the last planetary transmission stage finally drives the previously named second drive housing part 34 which forms the outer transmission house part and is rigidly connected to the roller body 9.

This rotatable housing part 34 is supported via a roller bearing arrangement 39 on the stationary housing part 40 which is formed by a bell housing which surrounds the transmission or motor shaft 19 at the transmission input and which is seated at a part expanded in diameter above the motor housing 21. Together with the named motor housing 21, the named bell housing, which forms the fixed housing part 40, is rigidly connected to a fastening flange 41 which is part of the roller carrier frame part 33 or is rigidly connected thereto.

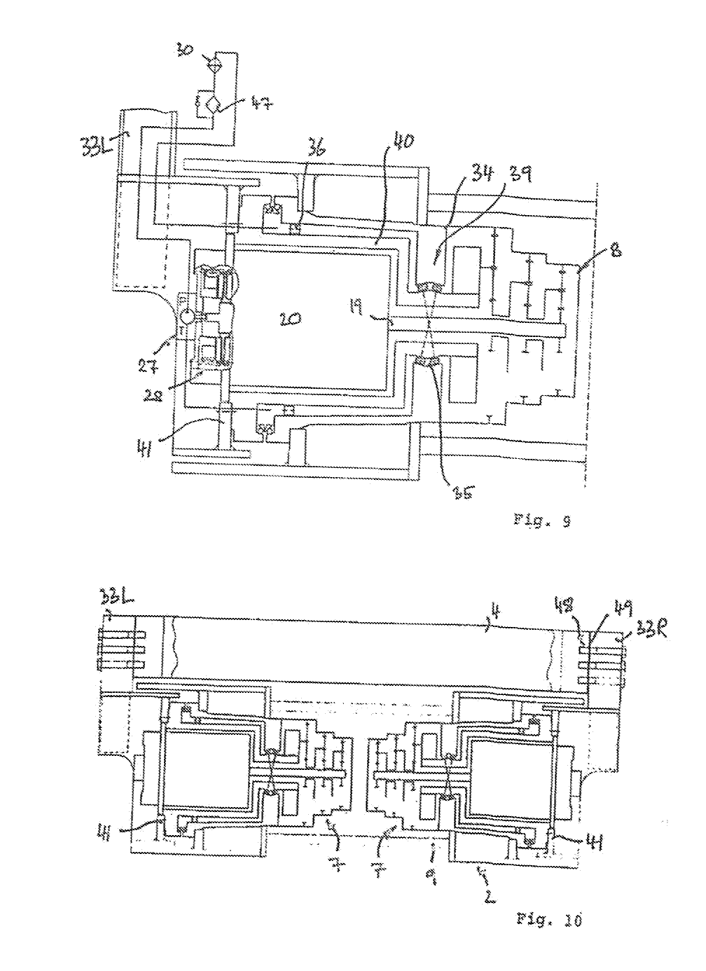

As FIGS. 2 and 8 show, the named roller bearing arrangement 39 in the drawn embodiment includes in the region of the transmission input the previously named fixed bearing 35 which is formed in the embodiments in accordance with FIGS. 2, 7, 8, 9, 10, 11 and 12 in the form of a double tapered roller bearing in an X arrangement. The named fixed bearing 35 takes up radial forces and axial forces so that the roller body 9 is fixed in an axially fixed manner to the roller carrier frame part 33 via the drive unit and its housing parts 34 and 40.

The exact angular alignment of the two housing parts 34 and 40 is, however, defined by the second bearing point which is arranged with a large support spacing from the named fixed bearing 35 and is formed by the named radial bearing 36. The named radial bearing 36 can advantageously be arranged over the periphery of the electric motor 20 preferably in the half of the electric motor spaced apart from the transmission 8, preferably as close as possible to the frame stem or to the previously named fastening flange 41. The named radial bearing 36 is, just like the fixed bearing 35, arranged between the previously named bell housing 40 and the outer transmission housing part 34.

As FIG. 8 shows, a sealing apparatus 42 is provided between the two mutually rotatable housing parts 34 and 40, with the named sealing apparatus 42 advantageously being able to be arranged as close as possible to the named radial bearing 36 over the periphery of the electric motor 20. The named sealing apparatus 42 can, for example, have simple radial shaft sealing rings. For a secure, leak-free sealing also under occurrence of heavy contamination, the named sealing apparatus 42 can, however, advantageously include floating ring seals which are fit between the two mutually rotatable housing parts 34 and 40.

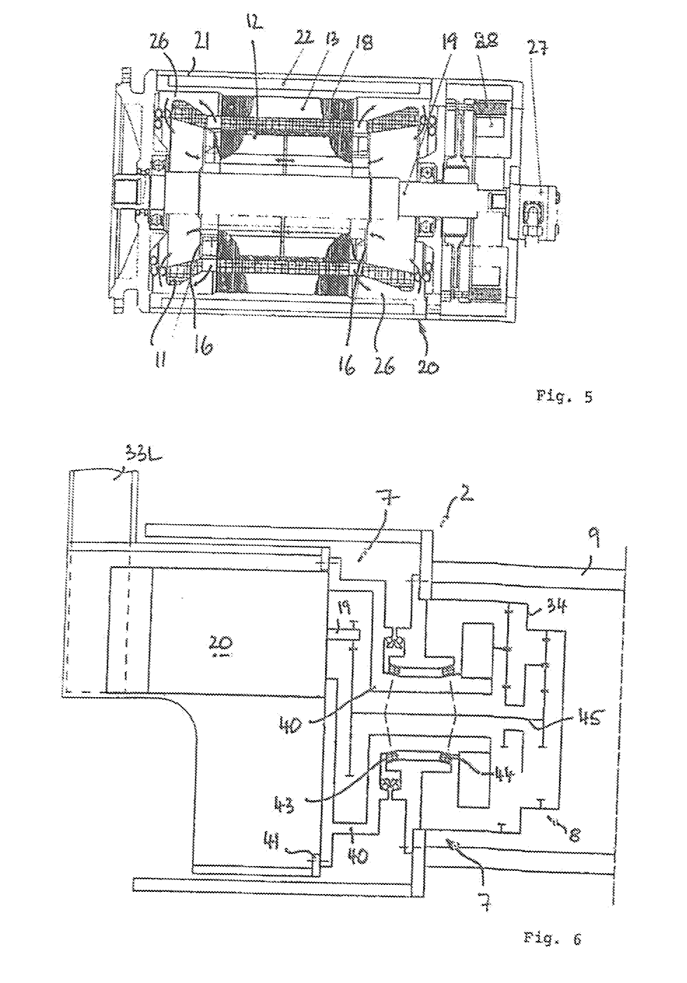

In accordance with the embodiment in accordance with FIG. 6, the roller bearing arrangement 39 can, however, also comprise two mutually spaced apart tapered roller bearings 43 and 44 or corresponding sloping ball bearings which are advantageously disposed in an O arrangement so that the effective support spacing is widened and an increased flexural stiffness is achieved accordingly. In accordance with the embodiment in accordance with FIG. 6, the named tapered roller bearings 43 and 44 are arranged in the region of the transmission input of the transmission 8, and indeed again between an outer transmission housing 34 and the bell housing 40 seated thereunder.

As FIG. 6 shows, such a design of the roller bearing arrangement 39 is advantageous for an axially offset arrangement of the electric motor 20 with respect to the transmission 8. The motor shaft 19 is transversely displaced with respect to the transmission input shaft 45 and is connected via a further transmission stage. The axially offset arrangement shown in FIG. 6 in particular also allows a plurality of electric motors 20 to be connected to a common planetary transmission, whereby smaller electric motors 20 can be used which together provide the required drive power.

In accordance with FIG. 2, at least two drive units 7 are advantageously provided in the interior of the roller body 9, with in particular a respective drive unit being provided to the right and to the left at the ends of the roller body 9, said respective drive unit advantageously being positioned so that it does not project out of the roller body 9 at an end face.

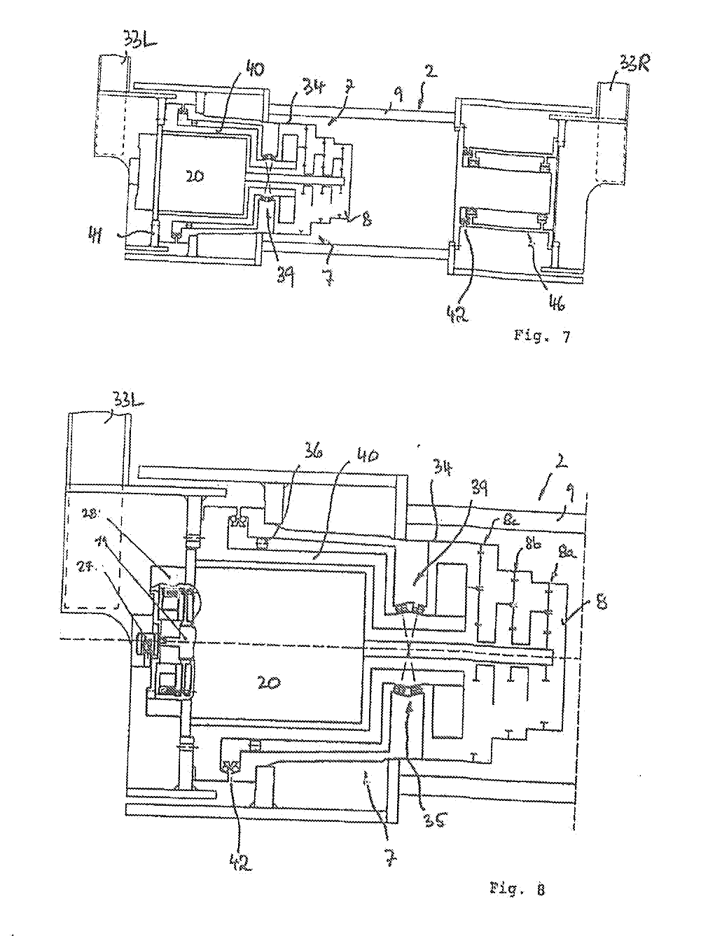

As FIG. 7 shows, however, only one drive unit 7 can also be provided in the interior of the rotary cutter. The roller drive 7 is here advantageously also arranged to one side—the left side in accordance with FIG. 7—of the rotary cutter, whereas a drive-free bearing arrangement 46 is provided on the opposite side which has a roller bearing arrangement including two spaced apart bearing points. A modular design of the rotary cutter can hereby be achieved which, depending on the power classification, allows the installation using the modular principle of one or two drive units, which can in this respect each be different, without having to modify the roller body.

As FIG. 7 shows, the bearing arrangement 46 includes two mutually rotatable housing parts which are mutually supported by a roller bearing arrangement. One of the housing parts is fastened to the roller body 9, while the other housing part is fastened to the roller bearing carrier frame part 33, cf. FIG. 7. The two housing parts of the bearing arrangement 46 can likewise be sealed by a sealing apparatus 42 of the aforesaid kind. The bearing arrangement 46 can then likewise be designed overall, for the same reasons as the bearing 39 on the drive side, in an axially and radially fixed manner and at a fixed angle, that is, can comprise a fixed bearing and a radial bearing spaced apart therefrom.

As FIG. 8 shows, a pump 27 is advantageously seated at the end of the drive shaft 19 of the electric motor 20 which faces the outer side of the roller body 9 of the rotary cutter 2, said pump being able to serve the circulation of the cooling liquid of the liquid cooling circuit 23 of the electric motor and/or the circulation of the lubricant of the planetary transmission 8 connected to the electric motor 20. If oil is used as the cooling liquid, the oil can optionally be pumped through the electric motor for cooling there and through the transmission for the lubrication and cooling there. Alternatively, the pump can, however, also include two separate pump stages of which the one circulates the cooling liquid and the other the lubricant of the transmission.

The named pump 27 is advantageously driven by the drive shaft 19 of the electric motor 20.

As FIG. 2 shows, a brake 28 can also be arranged at the named shaft end in addition to the pump 27. Optionally, even further additional elements such as a speed of revolution sensor can also be installed there. By the arrangement of the pump 27 and of the brake 28 outside the motor housing 21 on the shaft end of the electric motor 20 at the outer side of the rotary cutter, the named assemblies are easily accessible, whereby the availability of the machine can be further increased. This maintenance-friendly construction further provides the advantage that the brake 28 can nevertheless be utilized for an emergency stop even if it is only designed as a parking brake and even if it is thermally overloaded in so doing. A fast service is namely possible thanks to the accessibility. Furthermore, due to the attachment of the pump 27 to the shaft end of the electric motor 20, no further additional energy supply, for example via a cable, is necessary.

In particular the transmission 8 is supplied with oil via an oil circulation lubrication via the named pump 27. The pump 27 can in this respect be connected to the interior of the transmission 8 through a channel which extends through the motor shaft 19 of the electric motor 20, cf. FIG. 8.

As FIG. 9 shows, the oil or the lubricant can also be conducted by means of the pump 27 to a heat exchanger 30 which forms an oil cooler and can be arranged outside the roller body 9 on the machine body 4 to be flowed around better by the environmental air. As FIG. 9 shows, in this respect the coil can be conducted via a filter 47 with bypass, which results in improved oil purity and thus longer service life. The named oil cooler in the form of the heat exchanger 30 is arranged downstream of the named filter 47 so that the cooled and filtered oil can be conducted back into the transmission 8 again so that high permanent operation can be achieved without overheating and wear.

As FIG. 14 shows, the rotating drive housing part 34, which surrounds the transmission, is rotationally fixedly connected to the roller body 9 by at least one rotationally fixed connection point 80. As FIG. 14 shows, the roller body 9 can include a connection flange 81 which projects at the inner side and of which a peripheral surface radially supports the drive housing part 34 and/or of which an axial surface axially supports the drive housing part 34. The named connection parts 80 can in this respect include a screw connection 82 by means of which the named connection flange 81 is rigidly screwed to the drive housing part 34. As FIG. 14 shows, the drive housing part 34 can be axially clamped with a shoulder toward the named connection flange 81 by the screw connection 82.

To achieve a centration and/or tilt-resistant support of the rotating drive housing part 34, a further connection point can be provided, for example in the form of a centering flange 83 which likewise radially supports the drive housing part 34 axially spaced apart from the aforesaid connection flange 81.

To prevent fretting corrosion at the connection points between the roller body 9 and the rotating drive housing part 34, the roller body 9 is inwardly filled with oil or with another suitable lubricant so that the connection points 80 run in the oil bath at the connection flange 81 and at the centering flange 83. As FIG. 14 shows the level 91 of the lubricant bath is dimensioned such that at least the lower part of the drive housing part 34, including the connection points 80, runs in the oil bath and is wetted.

To achieve a circulation of the oil as well as an upward taking along of the oil, pusher impellers or web plates or similar circulation elements 100 can be provided in the interior of the roller body 9 which circulate with the roller body 9. For example, the named circulation elements 100 can be fastened to the roller body 9 at the inner peripheral side.

To ensure the oil distribution to all connection points with a plurality of connection points 80, oil openings or oil channels 120 can be provided at a suitable point. For example, a connection point disposed toward the roller center, in particular the centration flange 83, can be provided with an oil channel 120 for the oil distribution, cf. FIG. 14.

The inner space of the roller body is sealed toward the outer side. A sealing apparatus 110, for example in the form of an O ring, can be integrated into the connection point 80, cf. FIG. 14.

Since the drive units 7 which are used to support the rotary cutter 2 and also the bearing arrangement 46 each have statically determined roller bearing arrangements, the support of the rotary cutter 2 is per se statically overdetermined overall. To avoid restrictions and tensions, in a further development of the invention, the mutual position of the two roller carrier frame parts 33L, 33R engaging into the roller body 9 at an end face can be adjusted. The bearing adjustment device 48 provided for this purpose can in particular include axial adjustment means which make it possible change and adjust the mutual spacing of the named roller carrier frame parts 33L, 33R. As FIG. 10 shows, the position adjustment apparatus 48 can include simple adjustment washers 49 which can be disposed between the named roller carrier frame parts 33L, 33R and the corresponding machine body 4. A preferably planar interface is advantageously provided at least between one of the roller carrier frames 33L, 33R and the connection piece fixed at the machine frame and extends perpendicular to the axis of rotation of the rotary cutter 2 so that the spacing of the roller carrier frame parts 33L, 33R can be adjusted by insertion of the named adjustment washers 49. It is thereby prevented that longitudinal deviations cause too strong an axial tensioning of the bearings due to tolerances.

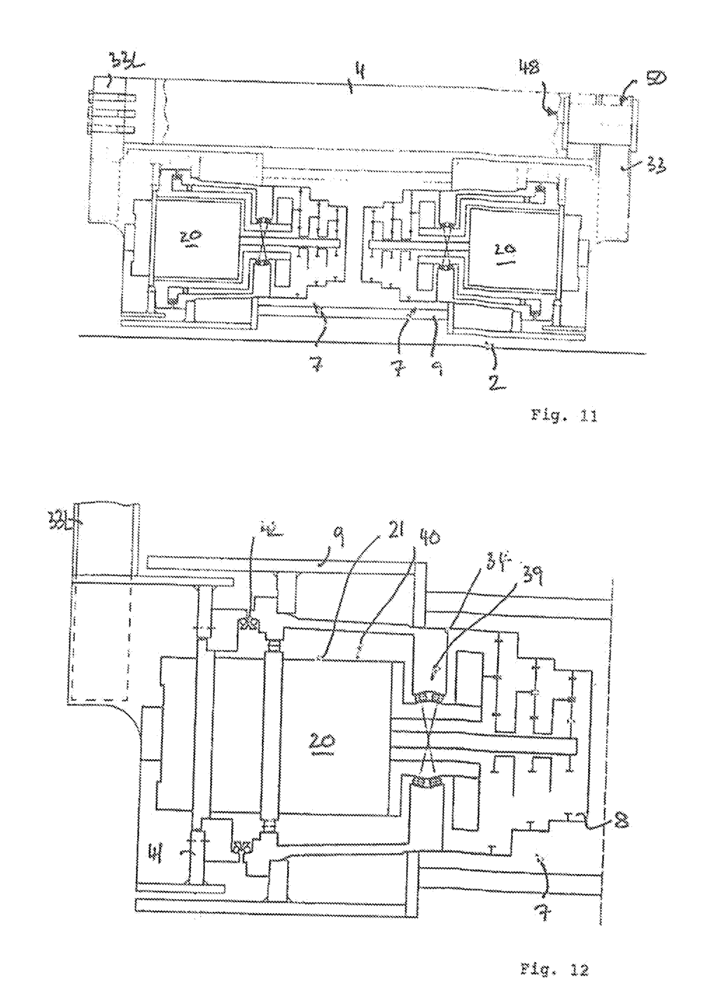

As FIG. 11 shows, at least one of the roller carrier frame parts 33 can also be movably supported at the machine body 4, in particular axially displaceably supported parallel to the axis of rotation of the rotary cutter 2 by means of a slide guidance 50. Varying axial displacements can hereby also be compensated, for example by changes in the temperature and/or deformations. The displaceably guided roller carrier frame part 33R can be fixedly connected to the machine frame, with the exception of the axial degree of freedom.

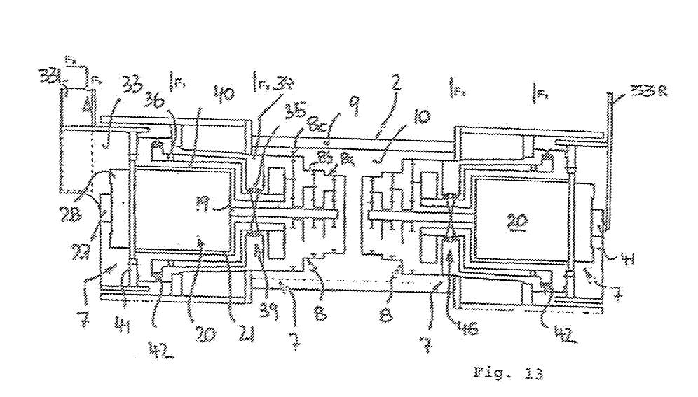

In accordance with FIG. 12, the stationary housing part 40 can also be formed by the motor housing 21 of the electric motor 20. In this case, the motor housing 21 advantageously forms a bearing shell for the previously described fixed bearing 35 of the roller bearing arrangement 39 or receives this bearing shell. Accordingly, a separate bell housing can be dispensed with, whereby a simple, slim and economically favorable design is obtained.

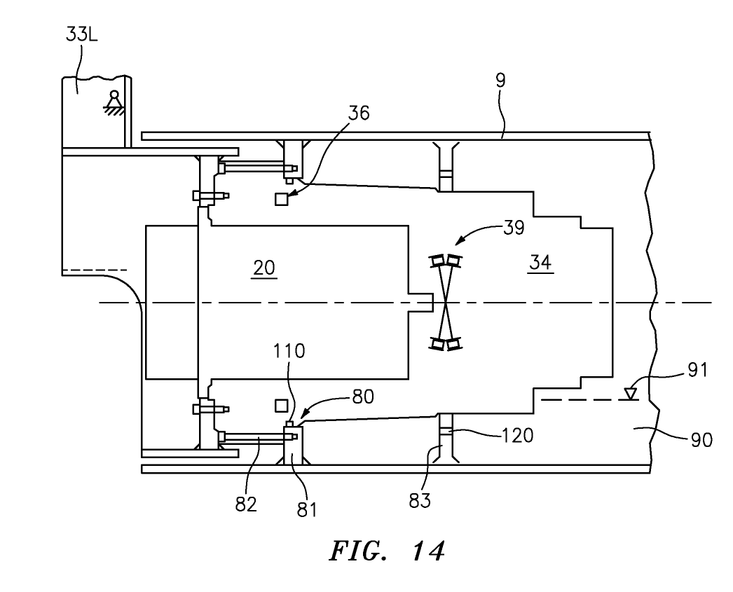

As FIG. 13 shows, at least one of the lateral roller carrier frame parts 33R engaging around the roller body at an end face can also be flexible and yielding in the axial direction so that the bearing point fastened to this roller carrier frame part 33R can be displaced in the axial direction parallel to the axis of rotation of the rotary cutter 2. The named roller carrier frame part 33R can in particular, viewed in the axial direction, be made considerably weaker and thinner than the oppositely disposed roller carrier frame part 33L, with the yielding and/or flexible roller carrier frame part 33R being formed, for example, in the form of a thin carrier flange which extends substantially perpendicular to the axis of rotation of the rotary cutter. Optionally, bar-shaped carrier sections can also be used here which permit the desired axial displaceability of the bearing point parallel to the axis of rotation of the rotary cutter 2.

An improved side cutting can simultaneously be achieved by the thin, flange-like or web-shaped formation of one of the lateral roller carrier frame parts 33R since it is possible to drive particularly close to rims or edges at this side since the lateral overhang of the carrier frame parts is considerably reduced at this side.

A generator is advantageously provided as the electric energy source for the electric motors 20 which is driven by an internal combustion engine, for example in the form of a diesel unit.

The electric motors 20 can advantageously be fed by the generator selectively via a frequency inverter or directly, i.e. without or with a bridging of the frequency inverter. A jumper so-to-say forms a bypass of the supply line around the frequency inverter, with the named jumper being able to be switched by a switching element, for example in the form of a breaker, so that the motor can selectively be fed via the frequency inverter or while bypassing it.

Instead of a plurality of electric motors 20, only one electric motor can also be provided for the drive of the main working unit 2. In the embodiment shown, two electric motors 20 are provided which are each drive-connected to the rotary cutter 2.

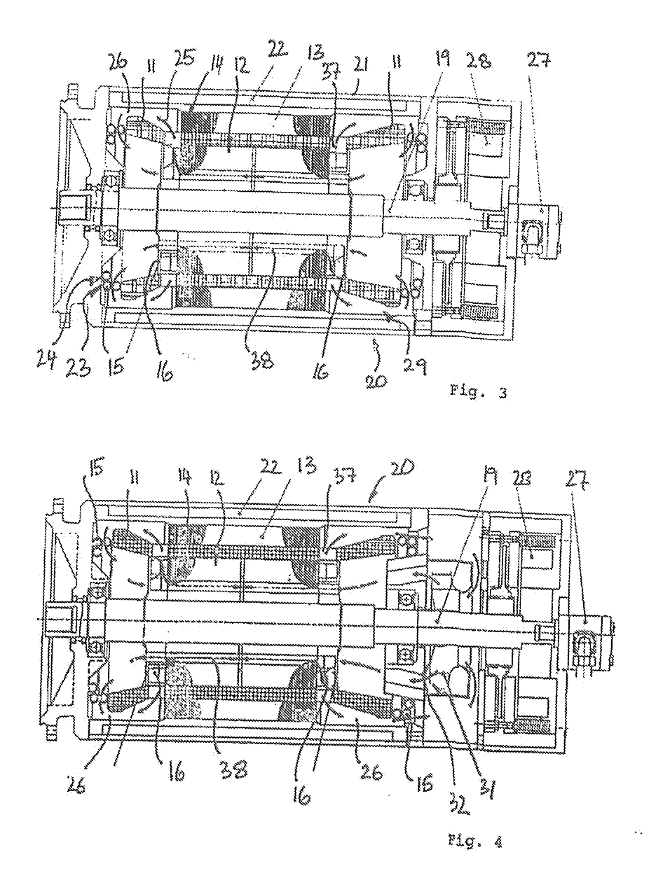

The electric motor 20 shown in FIG. 3 includes a shaft 19 with a rotor 12, said shaft being rotatably supported at bearing brackets which form part of a machine housing 21 and/or close a jacket 22 at an end face which surrounds the stator 13 of the machine 20. The named jacket 22 has a jacket cooling by which the cooling liquid of a liquid cooling circuit 23 is circulated. The named jacket is in this respect seated in a gap free, flush and/or areal manner on the stator plates to achieve a good heat transfer from the stator 13 into the cooling jacket 22.

In addition to the named liquid cooling circuit 23, the cooling apparatus 24 of the electric machine 20 includes an air cooling 25 for cooling the winding heads 11 which project on both sides of the stator 13 and of the rotor 12 into the winding head spaces 26 bounded by the housing 21, more precisely by the jacket 22 and by the bearing brackets. As FIG. 3 shows, the stator 13 includes a winding 14 which is partly embedded into the stator plate of the stator 13 and which forms basket-like winding heads 11 from both sides outside the named stator plate.

To cool the named winding heads 11, an internal cooling air circulation is effected by means of fan wheels 16 in each of the named winding spaces 26, i.e. no environmental air is conducted through the machine or over the winding heads 11, but an internal cooling air circuit is rather produced which cools the named winding heads 11. To remove the heat from the cooling air, cooling pipe coils 15 through which the cooling liquid is circulated are provided, as FIG. 3 shows, in the winding head spaces 26. The liquid cooling circuit conducted through the named cooling pipe coils 15 can generally be formed separately from the liquid cooling circuit 23 of the jacket cooling 22. Advantageously, however, a coupling of the cooling pipe coils 15 can be provided at the liquid cooling circuit 23 of the jacket cooling, with a parallel coupling or also a serial coupling of the cooling pipe coils 15 to the jacket cooling 22 and to the liquid cooling circuit 23 feeding it being able to be provided in dependence on the thermal load of the individual machine parts.

To achieve a high cooling effect on the circulating cooling air, the named cooling pipe coils 15 are advantageously provided on their outer side with ribbing, for example in the form of a plurality of axial ribs, at each cooling pipe to increase the heat transfer surface of the cooling pipe coils.

In the embodiment drawn in FIG. 3, the cooling pipe coils 15 are substantially seated at the end face of the winding heads 11 in a gap provided there between the end face of the named winding heads 11 and the bearing brackets, with the named cooling pipe coils 15 extending substantially in ring shape about the axis of the shaft 19.

The fan wheels 16, which effect the air circulation, are seated directly on the named shaft 19 in the embodiment in accordance with FIG. 3 and are driven by it. The named fan wheels 16 are in this respect advantageously received in the inner space 26 of the basket-shaped winding heads 11 in this respect. The fan wheels 16 are provided in the drawn embodiment with radially acting impeller blades so that they urge the air radially into the ring-shaped intermediate space which is bounded from the inside by the winding heads 11 and from the outside by the jacket 22, cf. FIG. 3.

As FIGS. 3 and 4 show, the winding heads 11 are provided at their neck, i.e. in the transition region to the stator plate, with radial passage cut-outs 37 which allow a passage of the cooling air through the winding heads 11.

The named passage cut-outs 37 form a part of channel means and channel conducting means which effect a ring-shaped air circulation around the basket-shaped winding heads 11, as the flow arrows in FIG. 3 illustrate. The cooling air urged by the fan wheels 16 to the neck of the respective winding head 11 there passes through the named passage cut-outs 37 and is then conducted on the outer side of the winding head 11, along it, between the winding head 11 and the jacket 22, to the end face of the respective winding head 11 and around this end face back to the inner side of the winding head 11. At the end face of the winding head 11, the cooling air in this respect sweeps over the cooling pipe coils 15 so that the heat is removed from the cooling air which was previously output from the winding of the winding head 11.

The cooling air guide furthermore includes air channels 38 through the rotor 12 from the one winding head space 26 to the other winding head space on the oppositely disposed side and back.

This cooling air guidance is effected by fan wheels 16 which are designed as attachment plates or compression plates and which directly contact the end face of the rotor 12 and are seated on the shaft 19. The fan wheels essentially comprise a radially projecting flange to which suitable air conveying means are fastened, for example in the form of conveying blades or conveying impellers, and at which air passage holes are formed which are distributed over the periphery and communicate with axial cooling air cut-outs or air channels 38 in the rotor 12 which extend axially in the named rotor 12 and each exit the named rotor 12 at the end face. In this respect, twice as many air channels 38 are provided in the rotor 12 as air passage holes in the attachment plates so that each of the attachment plates with their air passage holes only communicates with every second air channel 38 in the rotor 12. In this respect, the two attachment plates are rotationally offset from one another so that a first set of air channels 38 in the rotor 12 communicates via the air passage holes with the left hand inner space of the winding head 11, whereas a second set of air channels 38 of the rotor 12 communicates via the air passage holes in the other attachment plate with the inner space of the winding head 11 on the right hand side so that the cooling air circulation symbolized in FIG. 3 by the flow arrows is achieved.

The cooling air circulation is designed as follows: The fan part of the fan wheels 16 which works radially urges the cooling air through the passage cut-outs 37 provided at the neck of the winding heads 11 onto the outer side of the winding heads 11. The cooling air urged through the passage cut-outs 37 then circulates in a similar manner to the air guidance shown in FIG. 3 around the winding heads 11, with it sweeping on the outer side between the respective winding head 11 and the jacket 22, then around the end face of the winding head 11 and over the cooling pipe coils 15 from where it moves onto the inner side of the winding heads 11. The cooling air is urged from there into the air passage holes of the respective attachment plate which in this respect forms inlet passages for the air channels 38 of the rotor 12. The cooling air then flows through the named cooling air channels 38 through the rotor 12 in order to move on the other rotor side to the fan part of the fan wheel 16 of the attachment plate provided there. The cooling air then circulates there in a corresponding manner through and around the winding head 11 and then in the opposite direction back through the rotor 12 so that an oppositely directed cooling air flow is generated in the rotor 12 by the previously named two fan wheels 16.

The electric machine shown in FIG. 4 generally has a similar design to the machine in FIG. 3, with the difference thereto substantially being that the flow of the inner air flow is generated by a fan wheel 31 which is fastened outside the bearing bracket to the shaft and presses the inner air flow after the cooling pipe coil 15 of the right hand side in FIG. 4 into the air channels 38 of the rotor. The named bearing bracket in this respect has cooling air outlet openings and inlet openings so that the cooling air flow can circulate over the outer side of the named bearing bracket. For this purpose, a cup-shaped housing cap by which a closed cooling air circuit is provided is seated on the named outer side of the bearing bracket. On a standstill or at low revolutions, an intensive cooling of the electric motor 20 by a fan motor can be achieved. In this respect, the fan motor drives an additional fan wheel which is seated on the fan motor which is in turn seated on the outer side of the bearing bracket.

In the embodiment in accordance with FIG. 5, the electric motor is designed as a synchronous motor having a permanent magnet rotor which does not have any bars, but rather permanent magnets in the rotor. There are hereby practically no rotor losses so that the motor does not require any intensive motor cooling. As FIG. 5 shows, the liquid cooling circuit 23 can have a jacket cooling section to cool the jacket 22 and furthermore include, in the named manner, the cooling pipe coils 15 in the winding head spaces 26 to cool the cooling air there.

The permanent magnet motor 20 includes a rotor 12, which is equipped with permanent magnets 18 and is seated on the shaft 19, and a stator 13 which is cooled by the named jacket liquid cooling which can be connected in series, in parallel, or mixed, to an external heat exchanger. The fan wheels 16 seated on the motor shaft 19 set the inner air flow in the respective winding head spaces 26 into motion. The air flows in the respective winding head space 26 both over the winding 14 and the cooling pipe coils 15 which preferably comprise ribbed piping and form a closed circuit.

As FIGS. 3 to 5 show, a pump 27 is advantageously seated at the end of the drive shaft 19 of the electric motor 20 which faces the outer side of the roller body 9 of the rotary cutter 2, said pump being able to serve the circulation of the cooling liquid of the liquid cooling circuit 23 and/or the circulation of the lubricant of the planetary transmission 8 connected to the electric motor 20. If oil is used as the cooling liquid, the oil can optionally be pumped through the electric motor for cooling there and through the transmission for the lubrication and cooling there. Alternatively, the pump can, however, also include two separate pump stages of which the one circulates the cooling liquid and the other the lubricant of the transmission.

The named pump 27 is advantageously driven by the drive shaft 19 of the electric motor 20.

1. A self-propelled surface cutter, preferably in the form of an asphalt cutter, a snow cutter or a surface miner, having working equipment including a rotatingly drivable roller body (9), and having at least one roller drive unit (7) which is received in the interior of the roller body (9) and forms at least one part of a rotatable support of the roller body (9) at a roller carrier frame (33), wherein the rotatable support of the roller body includes at least two roller bearing arrangements (39, 46) which support the roller body (9) at two roller carrier frame parts (33R, 33L) engaging around the roller body (9) at an end face, wherein each of the named two roller bearing arrangements (39, 46) on its own forms a statically determined or overdetermined radial and axial support which includes at least two mutually spaced apart bearing points (35, 36; 43; 44) and supports the roller body (9) at the respective roller carrier frame part (33R, 33L) in an axially and radially fixed manner and/or at a fixed angle to one another so that the roller body (9) overall is supported with overdetermination at the roller carrier frame (33), and at least one axial compensation apparatus is provided at the roller carrier frame (33) and/or between the roller carrier frame and one of the roller bearing arrangements (39, 46) to compensate deviations of the axial spacing of the two roller bearing arrangements (39, 46) from the axial spacing of the bearing fastening points of the roller carrier frame parts (33R, 33L).

2. A self-propelled surface cutter in accordance with the claim 1, wherein the axial compensation apparatus has a movable frame bearing point for the axial movement of the roller carrier frame parts (33R, 33L) relative to one another in the direction of the longitudinal roller body axis.

3. A self-propelled surface cutter in accordance with the claim 2, wherein the named frame bearing point has an axial slide guidance (50) with an axial displaceability parallel to the longitudinal roller body axis.

4. A self-propelled surface cutter in accordance with claim 2, wherein the movable frame bearing point has a parallelogram arm guide for a roller carrier frame part (33R, 33L).

5. A self-propelled surface cutter in accordance with claim 1, wherein the roller carrier frame parts (33R, 33L) are freely displaceable relative to one another in the direction of the longitudinal roller body axis in operation.

6. A self-propelled surface cutter in accordance with claim 2, wherein the movable frame bearing point has a braking apparatus associated with it for the blocking of the degree of freedom of the frame bearing point.

7. A self-propelled surface cutter in accordance with claim 1, wherein the axial compensation apparatus has at least one position adjustment apparatus (48) for adjusting the position of at least one of the bearing fastening points at which the respective roller bearing arrangement is fastened to the respective roller carrier frame part (33R, 33L) relative to the respective roller carrier frame part (33R, 33L).

8. A self-propelled surface cutter in accordance with the claim 7, wherein the named position adjustment apparatus (48) has axial adjustment means for adjusting the axial position of the bearing fastening point of the roller bearing arrangement at the roller bearing frame part (33R, 33L) and thus for the adjustment of the axial spacing of the two bearing fastening points at the roller carrier frame parts (33R, 33L).

9. A self-propelled surface cutter in accordance with claim 1, wherein at least one of the roller carrier frame parts (9) engaging around the roller body (9) at an end face is designed as yielding, in particular flexible, in the axial direction such that the bearing point fastened to this roller carrier frame part (33R) is displaceable in the axial direction while deforming the roller carrier frame part (33R).

10. A self-propelled surface cutter in accordance with claim 1, wherein the roller carrier frame parts (33R, 33L) engaging laterally around the roller body (9) have different designs on the opposite sides of the roller body (9), with one of the roller carrier frame parts (33R), viewed in the axial direction, being thinner than the other roller carrier frame part (33L), preferably having a thickness in the axial direction of less than 50% of the thickness of the named other roller carrier frame part (33L).

11. A self-propelled surface cutter in accordance with claim 1, wherein the axial compensation apparatus is designed such that the bearing fastening points of the roller carrier frame parts are linearly displaceable in the axial direction parallel to the axis of rotation of the roller body, with the axial displacement being able to be carried out substantially free of tilt without rotation and transverse movement of the bearing fastening point.

12. A self-propelled surface cutter in accordance with claim 1, wherein the named roller carrier frame parts (33R, 33L) engaging around the roller body (9) at an end face are suspended in a tilt-resistant and non-pivotable manner.

13. A self-propelled surface cutter in accordance with claim 1, wherein at least one of the two bearing arrangements (9) is integrated into the at least one roller drive unit (7) which includes a stationary drive housing part (40) fastened to one of the roller carrier frame parts (33L, 33R) as well as a rotatable drive housing part (34) which is connected to the roller body (9), which are mutually sealed by a sealing apparatus (42) and are supported in an axially and radially fixed manner and at a fixed angle to one another by the named integrated roller bearing arrangement (39).

14. A self-propelled surface cutter in accordance with the claim 13, wherein a plurality of roller drive units (7) are provided having an integrated roller bearing arrangement (39) which is in each case statically determined or overdetermined.

15. A self-propelled surface cutter in accordance with claim 13, wherein the roller bearing arrangement (39) of at least one roller drive unit (7) has a bearing point directly beneath or directly next to the sealing apparatus (42) as well as a bearing point spaced apart from the sealing apparatus (42).

16. A self-propelled surface cutter in accordance with claim 1, wherein the roller drive unit (7) includes at least one electric motor (20) and a transmission (8) connected thereto, with the roller bearing arrangement (39) integrated into the roller drive unit having a bearing point in the region of the transmission (8), in particular in the region of the transmission input between the named drive housing parts (34, 40), and a bearing point in the region of the periphery of the electric motor (20), in particular in a half of the electric motor (20) remote from the transmission (8).

17. A self-propelled surface cutter in accordance with claim 1, wherein the roller bearing arrangement (39) includes two mutually spaced apart bearing points in the region of the transmission input of the transmission (8).

18. A self-propelled surface cutter in accordance with claim 1, wherein the roller bearing arrangement (39) of at least one roller drive unit (7) includes an axially fixed bearing, preferably in the form of a double tapered roller bearing in an X arrangement, and a radial bearing spaced apart therefrom.

19. A self-propelled surface cutter in accordance with claim 1, wherein the roller bearing arrangement (39) of at least one roller drive unit (7) has two mutually spaced apart tapered roller bearings or sloped ball bearings in an O arrangement.

20. A self-propelled surface cutter in accordance with claim 1, wherein the sealing apparatus (42) has sealing means in the region over the outer periphery of the electric motor for sealing the transmission (8) and/or for support (39).

21. A self-propelled surface cutter in accordance with claim 1, wherein the sealing apparatus (42) includes sealing means in the region between the electric motor (20.) and the transmission (8).

22. A self-propelled surface cutter in accordance with claim 1, wherein the sealing apparatus (42) has at least one floating ring seal.

23. A self-propelled surface cutter in accordance with claim 1, wherein the rotatable drive housing part (34) forms an outer transmission housing part.

24. A self-propelled surface cutter in accordance with claim 1, wherein the stationary drive housing part (40) is formed by a bell housing which is placed over the motor housing (21) of the electric motor.

25. self-propelled surface cutter in accordance with claim 1, wherein the stationary drive housing part (40) is formed at least partly by a motor housing part which advantageously forms or receives a bearing shell for a bearing of the roller bearing arrangement (39).

26. A self-propelled surface cutter in accordance with claim 1, wherein the stator (13) and the rotor (12) of the electric motor (20) are received in the inner space (29) of a motor housing (21) sealed in an airtight and/or dust-tight manner, with a cooling apparatus (24) having a closed liquid cooling circuit (23) being associated with the at least one electric motor (20) in the rotary cutter interior.

27. A self-propelled surface cutter in accordance with claim 26, wherein the liquid cooling circuit (23) has a heat exchanger (30) which is arranged outside the rotary cutter (2) for cooling the cooling liquid and which is connected via cooling liquid lines conducted out of the rotary cutter (2) at an end face to a section of the liquid cooling circuit (23) associated with the at least one electric motor (20).

28. A self-propelled surface cutter in accordance with claim 1, wherein a pump (27) for circulating the cooling liquid and/or a transmission lubricant is arranged at a shaft end of the drive shaft (19) of the electric motor (20) at the outer side of the rotary cutter.

29. A self-propelled surface cutter in accordance with claim 1, wherein the cooling apparatus (24) has a closed cooling air circuit (25) with forced circulation in the inner space (29) of the sealed motor housing (21) and the liquid cooling circuit (23) has a heat exchanger, preferably in the form of cooling pipe coils (15) for cooling the cooling air, which is swept over by the cooling air of the closed cooing air circuit (25).

30. A self-propelled surface cutter in accordance with claim 29, wherein at least one fan wheel (16) which is seated on the motor shaft (19) and is preferably in the form of a radial fan is provided for the forced circulation of the cooling air in the inner space (29) of the motor housing.

31. A self-propelled surface cutter in accordance with claim 29, wherein at least one fan wheel (31) which can be driven by a fan motor (32) separately from the motor shaft (19) is provided for he forced circulation of the cooling air in the inner housing (29) of the motor housing.

32. A self-propelled surface cutter in accordance with claim 1, wherein the electric motor (20) is formed as a synchronous motor with a permanent magnetic rotor.

33. A self-propelled surface cutter in accordance with claim 1, wherein the electric motor (20) is formed as an asynchronous motor.

34. A self-propelled surface cutter in accordance with claim 1, wherein a stator winding (14) has winding heads (11) arranged in a respective one winding head space (26) at oppositely disposed sides, wherein cooling pipe coils (15) of the liquid cooling circuit (23) are conducted outside the winding head (11) through the winding head spaces (26), and wherein the air cooling has two fan wheels (16) associated in each case with a winding head space (26) for generating an air flow which circulates within each winding head space (26) and which is conducted in a circulating manner by means of air channel means and/or air conducting means in the respective winding space over the exposed cooling pipe coils (15) and through the winding heads (11).

35. A self-propelled surface cutter in accordance with claim 34, wherein the air channel means and/or air conducting means include passage cut-outs (38) in the respective winding head (11) which are arranged at the neck of the winding heads (11), which are preferably of slit shape and which are distributed over the periphery of the winding head (11) and/or include cooling air cut-outs which pass through the winding heads (11) in the longitudinal direction and which are connected to the named passage cut-outs (37) at the neck of the winding heads (11).

36. self-propelled surface cutter in accordance with claim 34, wherein the air channel means and/or air conducting means define a plurality of flow paths which are conducted in ring shape around the winding heads (11) and which each include the named passage cut-outs (37), an outer section between the respective winding head (11) and the jacket (22), a flow path section at an end face between the winding head end faces and the bearing brackets as well as an inner section on the inner side of the winding heads (11).

37. A self-propelled surface cutter in accordance with claim 1, wherein the cooling pipe coils (15) are arranged at the end faces of the winding heads (11).

38. A self-propelled surface cutter in accordance with claim 1, wherein the winding head spaces (26) form closed air circulation spaces and are connected to one another via air channels (38) which pass through the rotor (12).

39. A self-propelled surface cutter in accordance with claim 1, wherein the air channel means and/or the air conducting means have a counterflow device for the conducting of cooling air through the rotor (2) in the opposite direction.

40. A self-propelled surface cutter in accordance with claim 1, wherein the roller body (9) has at least one connection point (80) for the rotationally fixed connection to a rotating drive housing part (34) of the at least one roller drive unit (7) and a lubricant reservoir (90) is provided in the interior of the roller body (9) for lubricating the named connection point (80) and/or for protecting the connection point (80) from fretting corrosion.

41. A self-propelled surface cutter in accordance with claim 40, wherein the lubricant reservoir (90) forms a lubricant bath having a level (91) which wets at least one section of the connection point (80) and/or at least a part of the drive housing part (34).

42. A self-propelled surface cutter in accordance with claim 40, wherein at least one circulation element (100) is provided in the interior of the roller body (9) for circulating the lubricant reservoir (90) on a rotation of the roller body (9) and/or a rotation of the drive housing part (34).

43. A self-propelled surface cutter in accordance with claim 41, wherein the connection point (80) and/or the inner space of the roller body (9) is sealed by a sealing apparatus (10) with respect to the rotating drive housing (34), with the sealing apparatus (110) preferably being integrated into the connection point (80) in the form of an O ring.
